(19) United States
(12) Patent Application Publication
(10) Pub. No.: US 2020/0159516 A1
(43) Pub. Date: May 21, 2020

(54) DEVICE SETUP AND UPDATES IN A MEDIA SYSTEM

(71) Applicant: Sony Corporation, Tokyo (JP)

(72) Inventors: Hyehoon Yi, San Diego, CA (US); Bibhudendu Mohapatra, San Diego, CA (US)

(73) Assignee: Sony Corporation, Tokyo (JP)

(21) Appl. No.: 16/193,216

(22) Filed: Nov. 16, 2018

(51) Int. Cl. G06F 8/65; H04N 21/6547; H04N 21/4363

(52) U.S. Cl. CPC G06F 8/65; H04N 21/43635; H04N 21/6547

(57) ABSTRACT

Implementations generally relate to setting up and updating media devices in a media system. In some implementations, a method includes receiving a signal at a television, wherein the signal is associated with at least one other media device. The method further includes determining a make and model of the at least one other media device based on the signal. The method further includes determining one or more settings of the at least one other media device based on the make and model of the at least one other media device. The method further includes configuring the one or more settings of the at least one other media device.

### BACKGROUND

Media device settings are typically configured using a remote control device for each media device. A user typically navigates through a main menu and submenus displayed on the media device or alternatively on a television screen, where the user can set various settings at desired values. It can be tedious and time consuming to find particular settings to set. Furthermore, if a given media has software that needs updating, the user needs to figure out how to download the updated software onto the media device. This may require connection of the media device to the Internet. Conventional solutions do not provide adequate means for facilitating a user in configuring such media device settings.

### SUMMARY

Implementations generally relate to setting up and updating media devices in a media system. In some implementations, a system includes one or more processors, and includes logic encoded in one or more non-transitory computer-readable storage media for execution by the one or more processors. When executed, the logic is operable to perform operations including receiving a signal at a television, wherein the signal is associated with at least one other media device; determining a make and model of the at least one other media device based on the signal; determining one or more settings of the at least one other media device based on the make and model of the at least one other media device; and configuring the one or more settings of the at least one other media device.

With further regard to the system, in some implementations, the television exchanges data with at least one other media device using a high-definition multimedia interface (HDMI). In some implementations, one or more of the settings comprises setup information associated with the at least one other media device. In some implementations, the logic when executed is further operable to perform operations comprising: determining that the at least one other media device is a new media device that has been connected to the television; and determining setup information associated with the at least one other media device. In some implementations, the at least one other media device is not connected to an Internet. In some implementations, the logic when executed is further operable to perform operations comprising: accessing an Internet; obtaining setup information associated with the at least one other media device; and configuring the one or more settings of the at least one other media device based on the setup information. In some implementations, the logic when executed is further operable to perform operations comprising: accessing an Internet; obtaining a software update based on the make and model of the at least one other media device; and installing the software update on the at least one other media device.

In some embodiments, a non-transitory computer-readable storage medium with program instructions thereon is provided. When executed by one or more processors, the instructions are operable to perform operations including receiving a signal at a television, wherein the signal is associated with at least one other media device; determining a make and model of the at least one other media device based on the signal; determining one or more settings of the at least one other media device based on the make and model of the at least one other media device; and configuring the one or more settings of the at least one other media device.

With further regard to the computer-readable storage medium, in some implementations, the television exchanges data with at least one other media device using a high-definition multimedia interface (HDMI). In some implementations, one or more of the settings comprises setup information associated with the at least one other media device. In some implementations, the logic when executed is further operable to perform operations comprising: determining that the at least one other media device is a new media device that has been connected to the television; and determining setup information associated with the at least one other media device. In some implementations, the at least one other media device is not connected to an Internet. In some implementations, the logic when executed is further operable to perform operations comprising: accessing an Internet; obtaining setup information associated with the at least one other media device; and configuring the one or more settings of the at least one other media device based on the setup information. In some implementations, the logic when executed is further operable to perform operations comprising: accessing an Internet; obtaining a software update based on the make and model of the at least one other media device; and installing the software update on the at least one other media device.

In some implementations, a method includes receiving a signal at a television, wherein the signal is associated with at least one other media device; determining a make and model of the at least one other media device based on the signal; determining one or more settings of the at least one other media device based on the make and model of the at least one other media device; and configuring the one or more settings of the at least one other media device.

With further regard to the method, in some implementations, the television exchanges data with at least one other media device using a high-definition multimedia interface (HDMI). In some implementations, one or more of the settings comprises setup information associated with the at least one other media device. In some implementations, the logic when executed is further operable to perform operations comprising: determining that the at least one other media device is a new media device that has been connected to the television; and determining setup information associated with the at least one other media device. In some implementations, the at least one other media device is not connected to an Internet. In some implementations, the logic when executed is further operable to perform operations comprising: accessing an Internet; obtaining setup information associated with the at least one other media device; and configuring the one or more settings of the at least one other media device based on the setup information. In some implementations, the logic when executed is further operable to perform operations comprising: accessing an Internet; obtaining a software update based on the make and model of the at least one other media device; and installing the software update on the at least one other media device.

A further understanding of the nature and the advantages of particular implementations disclosed herein may be realized by reference of the remaining portions of the specification and the attached drawings.

### BRIEF DESCRIPTION OF THE DRAWINGS

FIG. 1 illustrates a block diagram of an example media environment, according to some implementations.

FIG. 2 illustrates an example flow diagram for configuring a media device in a media environment, according to some implementations.

FIG. 3 illustrates an example flow diagram for setting up and updating a media device in a media environment, according to some implementations.

FIG. 4 illustrates a block diagram of an example network environment, which may be used for some implementations described herein.

FIG. 5 illustrates a block diagram of an example computing system, which may be used for some implementations described herein.

### DETAILED DESCRIPTION

Implementations described herein facilitate the setting up and updating of media devices in a media environment. As described in more detail herein, in various implementations, the system may be a television in a media or home theater environment, where the television may obtain setup information or software updates from the Internet. The system may then use such information to set up and/or update software for one or more media devices, which need not be connected to the Internet.

In some implementations, a system receives a signal at a television, where the signal is associated with at least one other media device of the media environment. The system further determines the make and model of the media device based on the signal. The system further determines one or more settings of the media device based on the make and model. The system then configures the one or more settings of the media device.

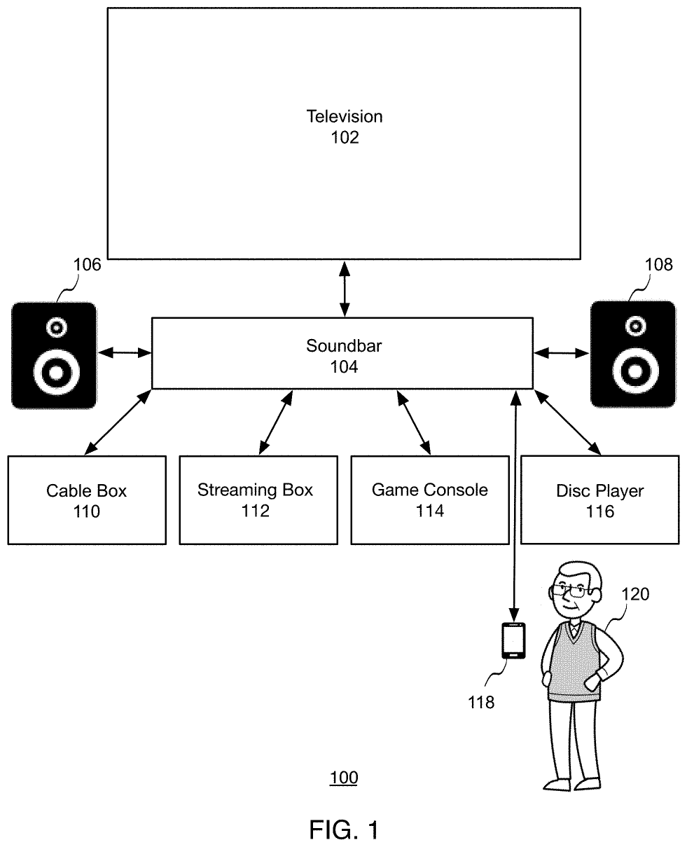

FIG. 1 illustrates a block diagram of an example media environment 100, which may be used for some implementations described herein. In some implementations, media environment 100 includes a television 102, a soundbar 104, speakers 106 and 108, a cable box 110, a streaming box 112, a game console 114, a disc player 116, and a remote control device 118. Also shown is a user 120.

In various implementations, a system that is integrated into television 102 facilitates the user in configuring the settings of other media devices such as soundbar 104, cable box 110, streaming box 112, game console 114, disc player 116, etc. As such, television 102 may be referred to as a master media device, and the other media devices soundbar 104, cable box 110, streaming box 112, game console 114, disc player 116, etc. may be referred to as peripheral devices, and may be referred to as slave media devices.

In various implementations, the media devices in media environment 100 are high-definition multimedia interface (HDMI) devices in that they can connect to each other via HDMI cables. HDMI enables the media devices to transfer large amounts of data between media devices (e.g., between television 102 and soundbar 104, etc.). While some implementations are described herein in the context of exchanging data via HDMI, these implementations and others also apply to exchanging data via HDMI-consumer electronics control (HDMI-CEC) or other digital means (e.g., fiber optic interfaces, etc.).

In various embodiments, the system (e.g., television 102) may identify HDMI devices connected to it (e.g., soundbar 104, cable box 110, streaming box 112, game console 114, disc player 116, etc.) via HDMI-CEC. Since the system is connected to the Internet and knows the identity of each connected media device, the system can search, find, and download relevant data such as setup information and software update files for each media device from the Internet. The system can in turn download the data to the appropriate media device over HDMI.

In some scenarios, a given media may have the capability of connecting to the Internet but the user might not know how to make the connection or might not want to. In some scenarios, a given media might not have the capability of connecting to the Internet. As such, the system may connect to the Internet on behalf of media devices that are not connected to the Internet for retrieving setup information and/or software updates.

In various implementations, television 102 may communicate with user 120 via a remote control device such as remote control device 118. In this particular example, remote control device 118 is a smart phone. In various implementations, the remote control device may be any remote control device such as one provided by the manufacture of television 102. As described in more detail herein, television 102 may also communicate with the user 120 by voice.

While some implementations are described herein in the context of the system residing in television 102, these implementations also apply to the system residing in other devices or located in other locations (e.g., in the cloud).

In other implementations, media environment 100 may not have all of the components shown and/or may have other elements including other types of elements instead of, or in addition to, those shown herein. In the various implementations described herein, a processor of television 102 may cause the elements described herein (e.g., settings, commands, messages, user preferences, etc.) to be displayed in a user interface on one or more display screens.

While some implementations are described herein in the context of a single media device, these implementations and others also apply to multiple media devices that are connected to television 102. For example, implementations described herein may include the system setting up and providing software updates for any one of cable box 110, streaming box 112, game console 114, and disc player 116, or any other media device connected to television 102.

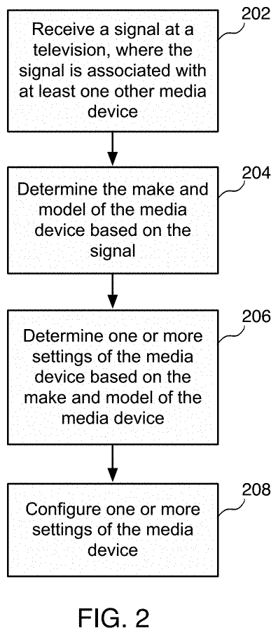

FIG. 2 illustrates an example flow diagram for configuring a media device in a media environment, according to some implementations. Referring to both FIGS. 1 and 2, a method is initiated at block 202, where a system such as television 102 receives a signal, where the signal is associated with at least one other media device in the media environment. For example, the other media device may be soundbar 104. If a user connects a brand-new soundbar device (e.g., soundbar 104) to television 102, both media devices may establish communication with each other. In some implementations, soundbar 104 may initiate communication by sending a signal to television 102, or vice versa. In either case, soundbar 104 may send a signal with information such as make and model number to television 102. In some implementations, television 102 may prompt the user via a graphical user interface (GUI) to ask whether the user would like to share Wi-Fi connection information with soundbar 102.

In various implementations, television 102 exchanges data with the media device using HDMI. As indicated above, HDMI is capable of transferring large amounts of data between media devices (e.g., between television 102 and soundbar 104, etc.). While some implementations are described herein in the context of exchanging data via HDMI, these implementations and others also apply to exchanging data via HDMI-CEC, fiber optic interfaces, etc.

At block 204, the system determines the make and model of the media device based on the signal. For example, soundbar 104 may have a particular model name and manufacturer. The system may also determine other information from the media device such as a serial number and associated date code.

At block 206, the system determines one or more settings of the media device based on the make and model of the media device. In various implementations, one or more of the settings includes setup information associated with the at least one other media device. For example, the system may determine that the media device is a new media device that has been connected to the television. In response, the system determines setup information associated with the media device.

At block 208, the system configures one or more settings of the media device. In some implementations, the system may also download other information to the media device such as a system identification (ID), password of streaming services, preferred picture settings, energy saving settings, etc. Some of this information shared by the system may include user-preferred television settings, including video and sound settings.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

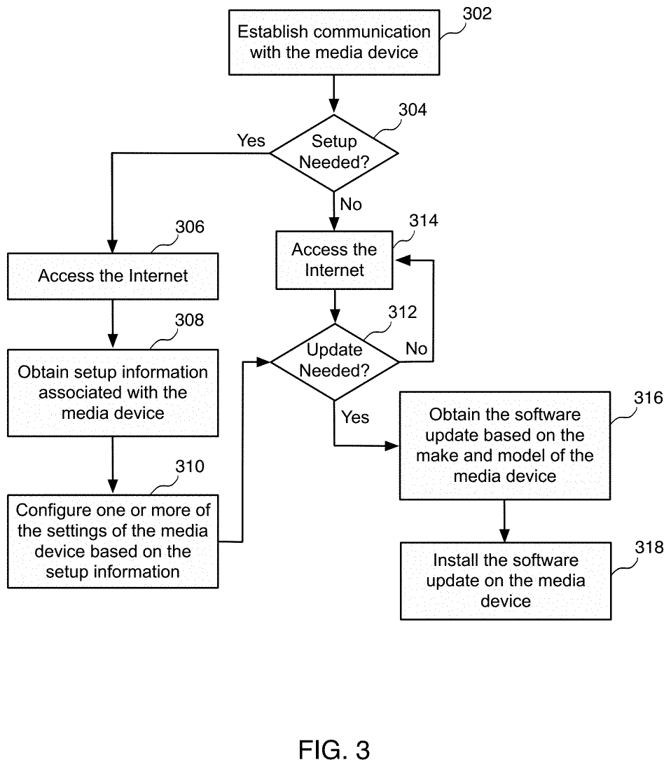

FIG. 3 illustrates an example flow diagram for setting up and updating a media device in a media environment, according to some implementations. In various implementations, the media device, such as soundbar 104, is not connected to the Internet. As such, television 102 accesses data from the Internet on behalf of the media device in order to setup and/or update the software on the media device.

Referring to both FIGS. 1 and 3, a method is initiated at block 302, where a system such as television 102 establishes communication with the media device. As indicated above, either the system or the media device may initiate communication.

At block 304, the system determines if the media device needs to be set up. For example, the system may determine if the system is connected to the media device for the first time. For example, if the media device is a brand new device, the media device may go into a setup mode upon power up. The system may detect the setup mode.

At block 306, if setup is needed, the system accesses the Internet. For example, the system may use stored Wi-Fi network and password information to access the Internet.

At block 308, the system obtains setup information associated with the media device. In various implementations, the setup information is based on the make and model of the at least one other media device. For example, the system may access the webpage of the manufacturer of the media device, and use the make and model and other information (e.g., serial number, etc.) provided by the media device to locate the appropriate setup information.

At block 310, the system configures one or more of the settings of the media device based on the setup information. In some implementations, the system may use at least some information obtained from the Internet to configure the settings of the media device. In some implementations, the system may also configure the settings of the media device based on store information in the system. For example, in the scenario where the main or master media device is television 102, television 102 may have stored video or audio settings, or stored user preferences that television 102 may use to configure the settings of the media device.

At block 312, after the system configures one or more of the settings of the media device at block 310, the system remains connected to the Internet and determines if the media device needs a software update.

At block 314, if a setup is not needed at block 304, the system accesses the Internet and then determines if the media device needs a software update at block 312. The system checks the existing software version installed on the media device and compares that software version to the latest software version available (e.g., at the manufacturers website, etc.). If the versions are the same, there is no need for an update. If there is a more recent release, the system proceeds to obtain the latest version of the software.

At block 316, the system obtains the software update based on the make and model of the media device.

At block 318, the system installs the software update on the media device. In various implementations, the system sends and downloads the latest software version/update to the media device and proceeds to install.

If a software update is not needed at block 312, the system periodically accesses the Internet at block 314 to determine if the media device needs a software update. In various implementations, the system performs periodic checks for software updates for multiple media devices connected to the system. In some implementations, the system may also report device model incompatibilities to both the user and the manufacturers. As such, software updates could more effectively support media systems with older model, or inform the user that a more recent model may work better with their existing system, etc.

In various implementations, the system may exchange menu tree information with the media device. For example, a main menu of television 102 may include the settings menu of the connected device. In some implementations, if there is sufficient bandwidth, HDMI may be used to simply share the Internet connection of the system (e.g., television 102) with the connected media device. As such, the media device may be enabled to access websites or media by using the system as a router.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

Implementations described herein provide various benefits. For example, implementations enable convenient setup and upgrades to media devices in a media system. Implementations significantly improve the user experience of maintaining the media devices of the media environment and keeping them up to date.

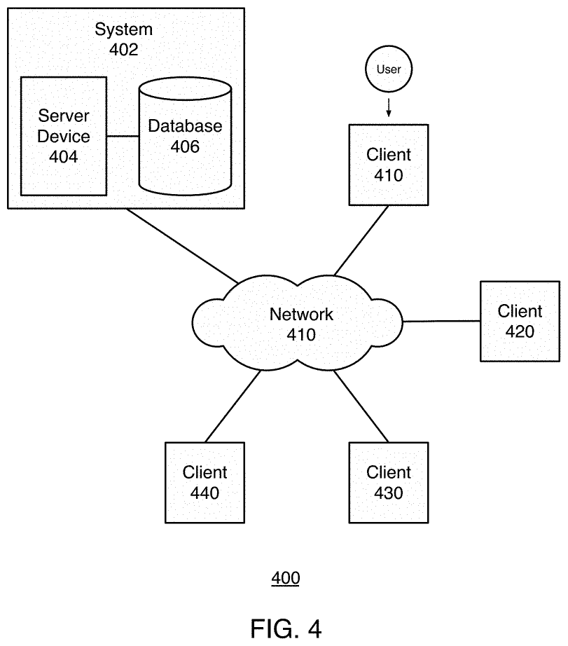

FIG. 4 illustrates a block diagram of an example network environment 400, which may be used for some implementations described herein. In some implementations, network environment 400 includes a system 402, which includes a server device 404 and a database 406. Network environment 400 also includes client devices 410, 420, 430, and 440 (each labeled “Client”), which may communicate with each other directly or via system 402. Network environment 400 also includes a network 450. Network 950 may be a Wi-Fi network, Bluetooth network, etc.

In various implementations, system 402 may represent a master device. Also, client devices 410, 420, 430, and 440 may represent other media devices in the media system. As indicated above, in various implementations, system 402 or the master device may be television 102, for example. In other implementations, system 402 or the master device may be another device in the media system, such as soundbar 104, etc.

For ease of illustration, FIG. 4 shows one block for each of system 402, server device 404, and network database 406, and shows four blocks for client devices 410, 420, 430, and 440. Blocks 402, 404, and 406 may represent multiple systems, server devices, and databases. Also, there may be any number of client devices. In other implementations, network environment 400 may not have all of the components shown and/or may have other elements including other types of elements instead of, or in addition to, those shown herein.

In the various implementations described herein, a processor of system 402 and/or a processor of any client device 410, 420, 430, and 440 causes the elements described herein (e.g., information, etc.) to be displayed in a user interface on one or more display screens.

Implementations may apply to any network system and/or may apply locally for an individual user. For example, implementations described herein may be implemented by system 402 and/or any client device 410, 420, 430, and 440. System 402 may perform the implementations described herein on a stand-alone computer, tablet computer, smartphone, etc. System 402 and/or any of client devices 410, 420, 430, and 440 may perform implementations described herein individually or in combination with other devices.

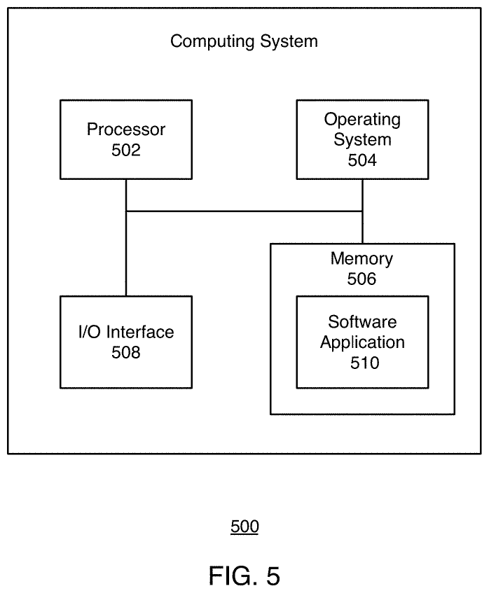

FIG. 5 illustrates a block diagram of an example computing system 500, which may be used for some implementations described herein. For example, computing system 500 may be used to implement the system described herein, including server device 504 of FIG. 5, as well as to perform implementations described herein. In some implementations, computing system 500 may include a processor 502, an operating system 504, a memory 506, and an input/output (I/O) interface 508. In various implementations, processor 502 may be used to implement various functions and features described herein, as well as to perform the method implementations described herein. While processor 502 is described as performing implementations described herein, any suitable component or combination of components of computing system 500 or any suitable processor or processors associated with computing system 500 or any suitable system may perform the steps described. Implementations described herein may be carried out on a user device, on a server, or a combination of both.

Computing system 500 also includes a software application 510, which may be stored on memory 506 or on any other suitable storage location or computer-readable medium. Software application 510 provides instructions that enable processor 502 to perform the implementations described herein and other functions. Software application may also include an engine such as a network engine for performing various functions associated with one or more networks and network communications. The components of computing system 500 may be implemented by one or more processors or any combination of hardware devices, as well as any combination of hardware, software, firmware, etc.

For ease of illustration, FIG. 5 shows one block for each of processor 502, operating system 504, memory 506, I/O interface 508, and software application 510. These blocks 502, 504, 506, 508, and 510 may represent multiple processors, operating systems, memories, I/O interfaces, and software applications. In various implementations, computing system 500 may not have all of the components shown and/or may have other elements including other types of components instead of, or in addition to, those shown herein.

Although the description has been described with respect to particular embodiments thereof, these particular embodiments are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A system comprising:
one or more processors; and
logic encoded in one or more non-transitory computer-readable storage media for execution by the one or more processors and when executed operable to perform operations comprising:
receiving a signal at a television, wherein the signal is associated with at least one other media device;
determining a make and model of the at least one other media device based on the signal;
determining one or more settings of the at least one other media device based on the make and model of the at least one other media device;
determines if the at least one other media device needs to be set up; and
configuring the one or more settings of the at least one other media device.

2. The system of claim 1, wherein the television exchanges data with the at least one other media device using a high-definition multimedia interface (HDMI).

3. The system of claim 1, wherein one or more of the settings comprises setup information associated with the at least one other media device.

4. The system of claim 1, wherein the logic when executed is further operable to perform operations comprising:
determining that the at least one other media device is a new media device that has been connected to the television; and
determining setup information associated with the at least one other media device.

5. The system of claim 1, wherein the at least one other media device is not connected to an Internet.

6. The system of claim 1, wherein the logic when executed is further operable to perform operations comprising:
accessing an Internet;
obtaining setup information associated with the at least one other media device; and
configuring the one or more settings of the at least one other media device based on the setup information.

7. The system of claim 1, wherein the logic when executed is further operable to perform operations comprising:
accessing an Internet;
obtaining a software update based on the make and model of the at least one other media device; and
installing the software update on the at least one other media device.

8. A non-transitory computer-readable storage medium with program instructions stored thereon, the program instructions when executed by one or more processors are operable to perform operations comprising:
receiving a signal at a television, wherein the signal is associated with at least one other media device;
determining a make and model of the at least one other media device based on the signal;
determining one or more settings of the at least one other media device based on the make and model of the at least one other media device;
determines if the at least one other media device needs to be set up; and
configuring the one or more settings of the at least one other media device.

9. The computer-readable storage medium of claim 8, wherein the television exchanges data with the at least one other media device using a high-definition multimedia interface (HDMI).

10. The computer-readable storage medium of claim 8, wherein one or more of the settings comprises setup information associated with the at least one other media device.

11. The computer-readable storage medium of claim 8, wherein the instructions when executed are further operable to perform operations comprising:
determining that the at least one other media device is a new media device that has been connected to the television; and
determining setup information associated with the at least one other media device.

12. The computer-readable storage medium of claim 8, wherein the at least one other media device is not connected to an Internet.

13. The computer-readable storage medium of claim 8, wherein the instructions when executed are further operable to perform operations comprising:
accessing an Internet;
obtaining setup information associated with the at least one other media device; and
configuring the one or more settings of the at least one other media device based on the setup information.

14. The computer-readable storage medium of claim 8, wherein the instructions when executed are further operable to perform operations comprising:
accessing an Internet;
obtaining a software update based on the make and model of the at least one other media device; and
installing the software update on the at least one other media device.

15. A computer-implemented method comprising:
receiving a signal at a television, wherein the signal is associated with at least one other media device;
determining a make and model of the at least one other media device based on the signal;
determining one or more settings of the at least one other media device based on the make and model of the at least one other media device;
determines if the at least one other media device needs to be set up; and
configuring the one or more settings of the at least one other media device.

16. The method of claim 15, wherein the television exchanges data with the at least one other media device using a high-definition multimedia interface (HDMI).

17. The method of claim 15, wherein one or more of the settings comprises setup information associated with the at least one other media device.

18. The method of claim 15, further comprising:
determining that the at least one other media device is a new media device that has been connected to the television; and
determining setup information associated with the at least one other media device.

19. The method of claim 15, wherein the at least one other media device is not connected to an Internet.

20. The method of claim 15, further comprising:
accessing an Internet;
obtaining setup information associated with the at least one other media device; and
configuring the one or more settings of the at least one other media device based on the setup information.
